(19) United States
(12) Patent Application Publication
(10) Pub. No.: US 2024/0259703 A1
(43) Pub. Date: Aug. 1, 2024

(54) SENSOR DEVICE AND METHOD FOR OPERATING A SENSOR DEVICE

(71) Applicant: Sony Semiconductor Solutions Corporation, Atsugi-shi, Kanagawa (JP)

(72) Inventor: Diederik Paul MOEYS, Stuttgart (DE)

(73) Assignee: Sony Semiconductor Solutions Corporation, Atsugi-shi, Kanagawa (JP)

(21) Appl. No.: 18/578,715

(22) PCT Filed: Jul. 20, 2022
(86) PCT No.: PCT/EP2022/070408

§ 371 Date: Jan. 12, 2024

(30) Foreign Application Priority Data
Jul. 21, 2021 (EP) 21186886.4

(51) Int. Cl. H04N 25/47

(52) U.S. Cl. CPC H04N 25/47

(57) ABSTRACT

A sensor device comprises a plurality of sensor units each of which being capable to detect the intensity of an influence on the sensor unit, and to detect as an event a positive or negative change of the intensity of the influence that is larger than a respective predetermined threshold, an event selection unit configured to randomly select for readout a part of the events that were detected by the plurality of sensor units during at least one predetermined time period and to perform the random selection repeatedly for a series of the at least one predetermined time periods, and a control unit configured to receive the selected part of the events for each of the at least one predetermined time periods.

### FIELD OF THE INVENTION

The present disclosure relates to a sensor device that is capable of event detection and a method for operating the same. In particular, the present disclosure is related to the field of event detection sensors reacting to changes in light intensity, such as dynamic vision sensors (DVS).

### BACKGROUND

Computer vision deals with how machines and computers can gain high-level understanding from digital images or videos. Typically, computer vision methods aim at excerpting, from raw image data obtained through an image sensor, that type of information the machine or computer uses for other tasks.

Many applications such as machine control, process monitoring or surveillance tasks are based on the evaluation of the movement of objects in the imaged scene. Conventional image sensors with a plurality of pixels arranged in an array of pixels deliver a sequence of still images (frames). Detecting moving objects in the sequence of frames typically involves elaborate and expensive image processing methods.

Event detection sensors like DVS tackle the problem of motion detection by delivering only information about the position of changes in the imaged scene. Unlike image sensors that transfer large amounts of image information in frames, transfer of information about pixels that do not change may be omitted, resulting in a sort of in-pixel data compression. The in-pixel data compression removes data redundancy and facilitates high temporal resolution, low latency, low power consumption, and high dynamic range with little motion blur. DVS are thus well suited especially for solar or battery powered compressive sensing or for mobile machine vision applications where the motion of the system including the image sensor has to be estimated and where processing power is limited due to limited battery capacity. In principle the architecture of DVS allows for high dynamic range and good low-light performance.

However, vision event detection sensors like DVS, but also event-based sensors of any other type, like e.g, auditory sensors, tactile sensors, chemical sensors and the like, can produce very large amounts of event data. This results in large throughput and therefore in queuing and processing delays together with increased power consumption. In fact, for a large data amount, i.e, for a large amount of events, the data output will not be sparse, which counteracts the positive characteristics of event-based sensors.

It is therefore desirable to utilize and pushing further the high temporal resolution of event-based sensors, in particular of photoreceptor modules and image sensors adapted for event detection like DVS.

### SUMMARY OF INVENTION

While event detection provides the above mentioned advantages, these advantages might be reduced for large amounts of events. For example, current read-outs for event-based sensors sacrifice speed and accuracy for data throughput. High-resolution Event-based Vision Sensors (EVS) sacrifice timing accuracy by using conventional frame-based read-out strategies, limiting timestamp accuracy. Arbitrated read-outs (burst-mode AER for example) which preserve timing order of the events are instead overwhelmed by the large number of events and introduce non-negligible activity-dependent jitter. The present disclosure mitigates such shortcomings of conventional event detection sensor devices.

To this end, a sensor device is provided that comprises a plurality of sensor units each of which being capable to detect the intensity of an influence on the sensor unit, and to detect as an event a positive or negative change of the intensity of the influence that is larger than a respective predetermined threshold, an event selection unit configured to randomly select for readout a part of the events that were detected by the plurality of sensor units during at least one predetermined time period and to perform the random selection repeatedly for a series of the at least one predetermined time periods, and a control unit configured to receive the selected part of the events for each of the at least one predetermined time periods.

Further, a method is provided for operating a sensor device comprising a plurality of sensor units each of which being capable to detect the intensity of an influence on the sensor unit, and to detect as an event a positive or negative change of the intensity of the influence that is larger than a respective predetermined threshold, the method comprising: detecting events by the sensor units: randomly selecting for readout a part of the events that were detected by the plurality of sensor units during at least one predetermined time period and to perform the random selection repeatedly for a series of the at least one predetermined time periods; and transmitting the selected part of the events for each of the at least one predetermined time periods to a control unit of the sensor device.

Sparse event data which is produced in high amounts loses its sparsity properties and advantages. To mitigate this, the above described additional sampling of the event data is introduced to further reduce the data while retaining important features and suppressing highly active sensor units (like hot pixels in DVS/EVS sensors). In particular, it has shown that a randomized selection is an efficient way of representing information. Randomly selected samples can capture important details which can still be correctly interpreted after output. The sensor devices and methods of the present disclosure can therefore effectively deal with the situation of large amount of events. Accordingly, the advantages of event-based sensors, in particular their high temporal resolution, can also be used for complex situations that produce a large amount of events.

### BRIEF DESCRIPTION OF THE DRAWINGS

FIG. 1 is a simplified block diagram of a sensor device for event detection.

FIG. 2 is a schematic diagram showing event number counts.

FIG. 3 is a schematic process flow of a method for operating a sensor device for event detection.

FIG. 4A is a simplified block diagram of the event detection circuitry of a solid-state imaging device including a pixel array.

FIG. 4B is a simplified block diagram of the pixel array illustrated in FIG. 4A.

FIG. 4C is a simplified block diagram of the imaging signal read-out circuitry of the solid state imaging device of FIG. 4A.

FIG. 5 is a simplified perspective view of a solid-state imaging device with laminated structure according to an embodiment of the present disclosure.

FIG. 6 illustrates simplified diagrams of configuration examples of a multi-layer solid-state imaging device to which a technology according to the present disclosure may be applied.

FIG. 7 is a block diagram depicting an example of a schematic configuration of a vehicle control system.

FIG. 8 is a diagram of assistance in explaining an example of installation positions of an outside-vehicle information detecting section and an imaging section of the vehicle control system of FIG. 7.

### DETAILED DESCRIPTION

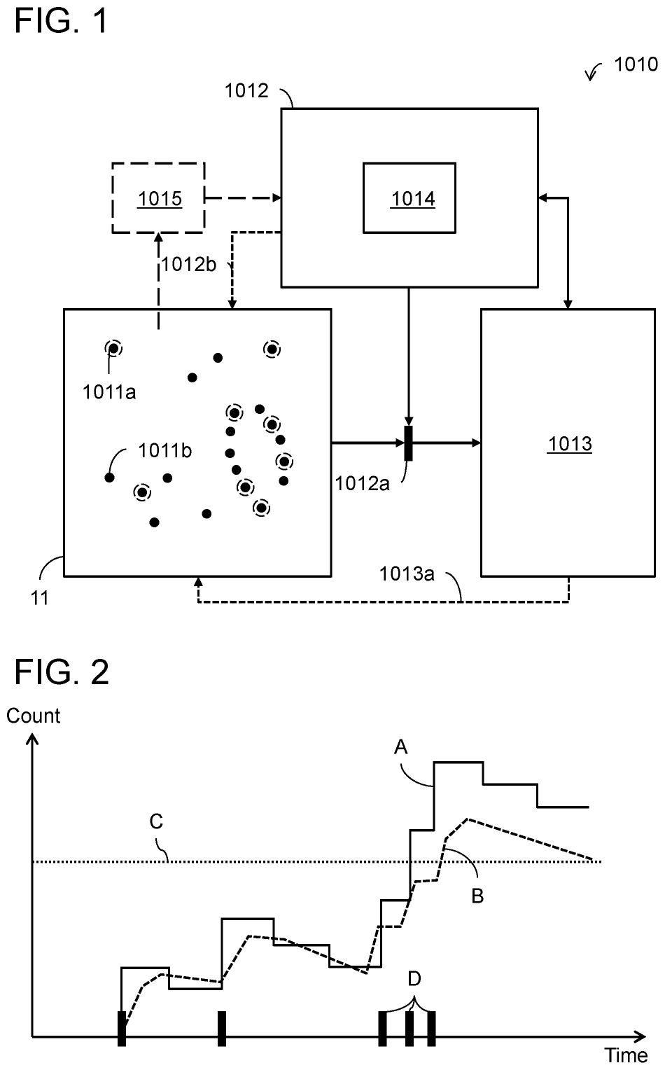

FIG. 1 is a schematic block diagram of a sensor device 1010 that is capable to detect events. As shown in FIG. 1 the sensor device 1010 comprises a plurality of sensor units 1011, an event selection unit 1012 and a control unit 1013. The sensor device 1010 may optionally also comprise a random number generator 1014 and a counting device 1015.

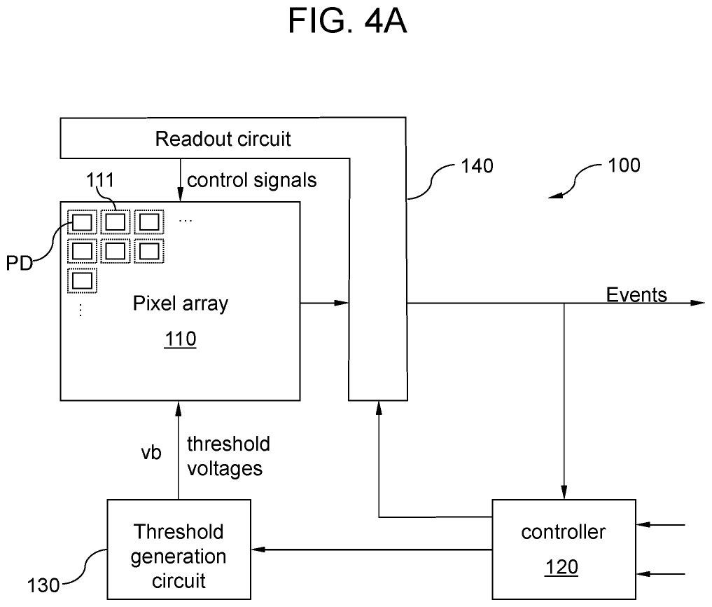

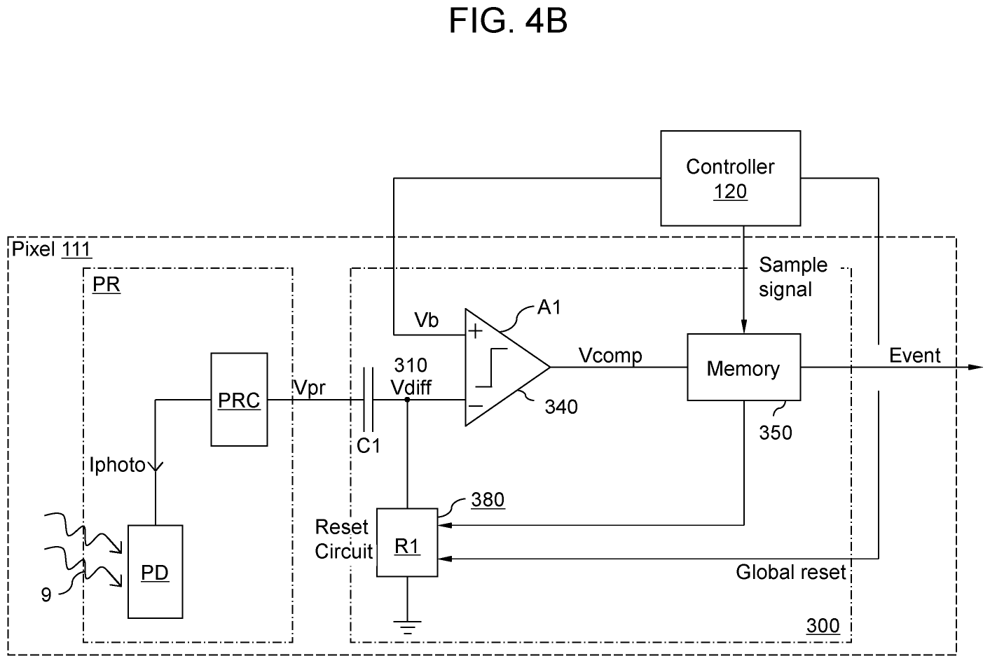

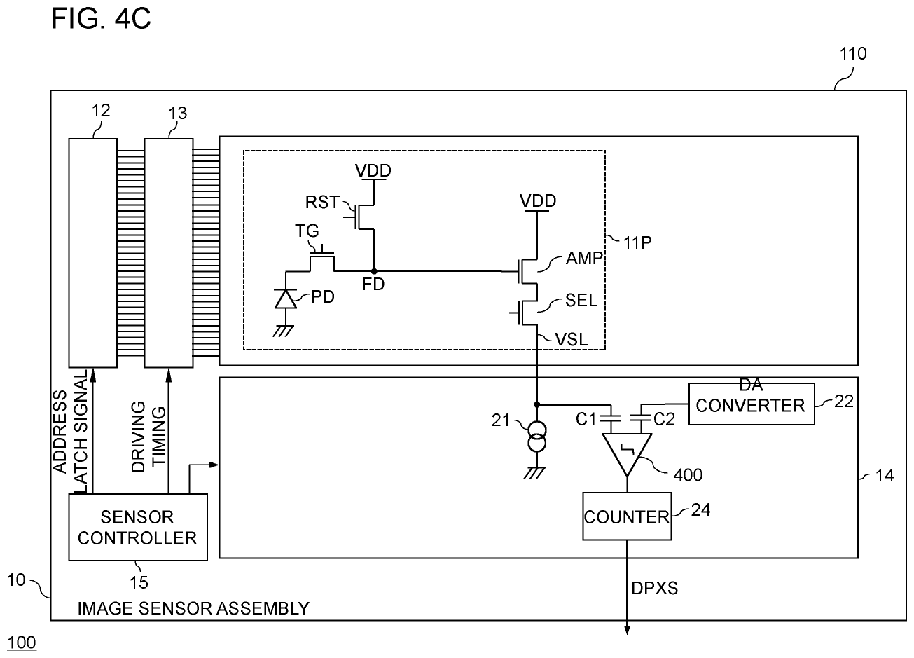

Each of the sensor units 1011 is capable to detect the intensity of an influence on the sensor unit 1011, and to detect as an event a positive or negative change of the intensity of the influence that is larger than a respective predetermined threshold. The influence detectable by the sensor units 1011 may be any physical or chemical influence that can be measured. The influence may for example be one of electromagnetic radiation (e.g. infrared, visible and/or ultraviolet light), sound waves, mechanical stress or concentration of chemical components. The sensor units 1011 have a configuration as necessary to measure the respective influence that is of interest for the sensor device 1010. The respective configurations of the sensor units are in principle known and can therefore be omitted here. For example, for the sake of detection of electromagnetic radiation the sensor units 1011 may constitute imaging pixels of a dynamic vision sensor, DVS, like described below starting with FIG. 4A. But any event based sensor, like an auditory sensor (as e.g. silicon cochleae) or a tactile sensor may be used as sensor unit 1011.

The plurality of sensor units 1011 has a certain distribution in space. As illustrated in FIG. 1, the sensor units 1011 may be arranged in an array or matrix form, like e.g. known for imaging pixels or tactile sensors. But the sensor units 1011 may also be freely distributed in space with a predetermined spatial relation, as e.g, auditory sensors or concentration sensors that are distributed in a room.

As in principle known, each of the sensor units 1011 monitors or measures the intensity of the influence acting on it such as e.g. light intensity in a given wavelength range, a sound amplitude, a pressure, a temperature value and the like. If the intensity changes by more than a predetermined threshold (to the positive or the negative) the sensor unit 1011 notifies to the control unit 1013 that an event (of positive or negative polarity) has been detected together with its address and/or identification and requests readout of the event by the control unit 1013. After readout the intensity value triggering event detection is used as new reference value for the following intensity monitoring. Event detection thresholds may vary between different sensor units 1011, may be dynamically set, and may be different for positive and negative polarity event detection.

The control unit 1013 reads out the events detected by the sensor units 1011, either in real time or repeatedly after given time periods, such as e.g, periodically. The control unit 1013 may be any kind of processor, circuitry, hardware or software capable of reading out the events. The control unit 1013 may be formed as a single chip with the rest of the sensor device's 1010 circuitry or may be a separate chip. The control unit 1013 and the sensor units 1011 may also be (at least partly) formed by the same components. The control unit 1013 is configured to perform processing on the detected event data to construct e.g. visual or tactile images from the event data, or to perform pattern recognition on the distribution of event data over the different sensor units 1011. To this end the control unit 1013 may use artificial intelligence systems. Further, the control unit 1013 may be capable to control the overall functioning of the sensor device 1010.

The processing of event data leads usually to an improved temporal resolution compared to the processing of the full intensity signal. However, for a large number of events this advantage can be reduced, since the reduction of the data amount obtained by event processing is balanced or even outbalanced by the number of events. For example, large motions (ego-motions) and brightness changes in the scene cause large quantities of events in a DVS or EVS sensor. Similarly, complex stimuli in event-based auditory sensors such as silicon cochleae stimulate heavily all channels and produce many events. In general, also any other type of overly-stimulated or large event-based sensor will produce large amounts of event data which limits throughput, precision and power savings as in the two examples above.

This problem can be solved by applying the principle that also a randomized search can efficiently represent information.

To this end, the sensor device 1010 comprises the event selection unit 1012. The event selection unit 1012 is configured to randomly select for readout a part of the events that were detected by the plurality of sensor units 1011 during at least one predetermined time period and to perform the random selection repeatedly for a series of the at least one predetermined time periods. Thus, instead of simply allowing readout of all the detected events an event selection is carried out by the event selection unit 1012. This reduces the event-data coming out either of each the pixel units 1011 or of the plurality of sensor units 1011 as a whole by imposing variational constraints: the shape of the temporal and spatial sampling distribution of the events that make it out of the sensor.

So, as illustrated exemplary in FIG. 1 by switch 1012a, the event selection unit 1012 filters out from all the events that were detected during a predetermined time interval (e.g. a readout cycle) a certain number of events in order to reduce the amount of data that needs to be processed. The selection is made randomly, i.e, it follows a given probability distribution for the selection of each sensor unit 1011. As illustrated in FIG. 1, only some sensor units 1011a are selected for readout, while most sensor units 1011b are not.

During the predetermined time period the control unit 1013 may allow detection of only one event for each of the sensor units 1011. The predetermined time interval may have a length of a few microseconds to a few milliseconds. Event selection during the predetermined time period can then be considered as a purely spatial selection out of the spatially distributed sensor units 1011. However, the random selection may also be applied to all the events that were detected during a consecutive plurality of such predetermined time periods. The selection is then spatio-temporal in that a subset of detected events that is distributed over space and time is selected by the event selection unit 1012.

The control unit 1013 is configured to receive the selected part of the events for each of the at least one predetermined time periods. The control unit 1013 may either gather the selected events, may process them or may forward them e.g. to a field programmable array. FPGA, a computer, or the like. Based on the time series of selected events, reconstruction of the original intensity signal or time varying components of the intensity signal can be performed as would be the case for the full set of event data. It has been shown that for most applications no significant deterioration of the reconstruction is observed due to the random selection. In fact, due to the random selection the number of the selected events may lie between 5% and 35%, preferably between 10% and 15%, of the total number of events detected during the predetermined time period or the consecutive series of predetermined time periods without generating deteriorations.

In this manner the temporal resolution of event based detectors can be maintained even for large amounts of events. Moreover, energy consumption and necessary processing power can be reduced.

As illustrated in FIG. 1, the event selection unit 1012 may comprises the random number generator 1014 for random event selection. The random number generator 1014 is of a principally known type and capable to generate a random series of numbers according to a probability distribution, with one number associated to each event that was detected during the at least one predetermined time period or the consecutive series of predetermined time periods. For example, the random number generator 1014 may produce a series of zeros and ones, wherein the order and number of ones is randomly distributed. The order and number of ones may e.g. be dictated by thermal noise or 1/f noise. The probability to have a one may follow a uniform distribution, a Poisson distribution, a Gaussian distribution or any other probability distribution. Alternatively, to each of the sensor units 1011 that have detected an event a natural number between 0 and N may be assigned, wherein the value of the number is dictated by a uniform distribution (with probability of 1/(N+1) for each number), a Poisson distribution, a Gaussian distribution or any other distribution. Such random number generators are in principle known to a skilled person, for which reason further explanation can be omitted here.

Based on the random number generated by the random number generator 1014, the event selection unit 1012 is configured to select those events that are associated to a number above a threshold. For example, if the random number generator 1014 produces a series of zeros and ones, all events from sensor units 1011 to which a one is assigned will be selected. If the random number takes a value between 0 and N, any appropriate threshold can be selected, depending on the number of events one aims to select. For example, a threshold could be all events having numbers between N/4 and 3N/4, all events above N/2, or even a set of non-consecutive numbers out of all numbers between 0 and N. Here, the threshold may be adjustable dynamically, e.g. by the control unit 1013, in order to allow adaption of the selected number of events to the total number of detected events.

Using a known probability function for obtaining the random numbers or at least a known principle how they are obtained may help to reconstruct the intensity information of interest, since the selection principle may be used to understand which part of all the events was selected. In this manner, the number of selected events can be further reduced without deteriorating the reconstruction results.

As one example of a dynamic adaption of event selection, the event selection unit 1012 may be configured to adjust the likelihood for selection of an event generated by one of the sensor units 1011 based on the number of events previously detected by said sensor unit 1011 during a predetermined time duration such that the likelihood for selection decreases with an increasing number of previously detected events. To this end, e.g. the control unit 1013 may set a separate threshold for each of the sensor units 1011 that is a function of the number of events detected by this sensor unit 1011 during a series of the last predetermined time periods.

In the example of random numbers between 0 and N a basic threshold that applies for “zero events detected” may be scaled depending on the underlying probability distribution. The more events were previously detected, the more the threshold is adjusted such that only improbable numbers will meet it. If, for example, the positive part of a Gaussian distribution centered at zero is used and a basic threshold is a natural number n, then an adjusted threshold may be created by multiplying n by the number of previously detected events. This will decrease the likelihood for event selection for a frequently active sensor unit 1011.

Just the same, instead of adjusting the threshold, the number assigned by the event selection unit 1012 to each sensor unit 1011 may be weighed based on the number of events detected previously by each sensor unit 1011. For example, if zero or one is assigned to each sensor unit 1011, and a threshold for event selection is set to 0.5, then each sensor unit 1011 may be weighed by n⁻¹, n^{-1/2}, or the like, with n the number of previously detected event. Also in this manner frequently active sensor units 1011 can be muted.

Thus, by dynamically adjusting the likelihood for event selection based on the number of previously detected events, erroneously active sensor units 1011, such as e.g. hot pixels in a DVS or EVS, can be disregarded. This helps preventing unnecessary computing and power consumption. Moreover, situations producing a time series of events on the same sensor unit can also be characterized by only the beginning of this time series, allowing increasing the probability to disregard the remaining series. This allows obtaining a random, but intelligent selection of events that contain the most useful information.

Besides focusing only on a single sensor unit 1011, when adjusting the likelihood for event selection, one may also consider groups of sensor units 1011. For example, different sensor units 1011 may be arbitrarily grouped together, where the number of events detected by all of them will decrease the likelihood for event selection for all of them. For a spatially well-defined arrangement of sensor units 1011, as e.g. the imaging pixels of a DVS, one may consider sensor units 1011 being nearest neighbors as one group (like e.g, each pixel and the adjacent or surrounding pixels). The likelihood may also be decreased in a staggered manner, with a central sensor unit 1011 having detected a large number of events being decreased the most, while surrounding, adjacent or neighboring sensor units 1011 being less decreased the more distant they are from the central sensor unit 1011. Here, for the decrease of selection likelihood of a non-central sensor unit 1011 due to the central sensor unit 1011, the number of events detected by the non-central sensor may be irrelevant for the decrease or may be counted in. This leads to a situation, in which the adjustment of the selection likelihood depends for each sensor unit 1011 on two factors: first the self-detected events and second the event detected by sensor units 1011 in the same group.

This allows to group sensor units 1011 together that will produce most likely also events together, like e.g. neighboring imaging pixels. In this manner, random event selection becomes even more intelligent in that from such groups only a given number of events will be accepted that is sufficient for reconstruction of the intensity signal, while the likelihood of selection of redundant information is reduced. This allows a sparser selection, by which the timing resolution and the energy consumption can be further improved.

As a further alternative and/or additional example, the event selection unit 1012 may be configured to adjust the likelihood for selection of an event depending on the total number of events detected during the at least one predetermined time period. Thus, if only a small number of events are generated, it will be possible to adjust overall likelihood of detection to a high value, e.g. 1 or close to one. If the number of events increases, this likelihood can be decreased in order to reduce the risk of an overrun of the processing structure due to a too large number of readout events.

In particular, the event selection unit 1012 may be configured to adjust the likelihood for selection such that a total number of selected events is within a predetermined range. So, the number of events to be read out and to be processed can be adjusted to be in a certain range with which the control unit 1013 and/or subsequent processing stages can cope. Further, the fact is taken into account that complex situations producing many events contain a higher percentage of redundant information than situations producing only a small number of events. Thus, by adjusting likelihoods for event selection additionally and/or alternatively such that the total readout event number is fixed to a certain range, it is possible to obtain good and fast processing results without overly deteriorating the results.

The number of previously detected events can either be stored and managed by the event selection unit 1012 or the control unit 1013. The control unit 1013 is configured to determine the necessary adaption of the likelihood for selection (e.g. by threshold or weighing factor adaption) and to control the event selection unit 1012 to perform event selection accordingly. However, the event selection unit 1012 may also do the determination on its own. Further, the number of previously detected events may also be stored in the respective sensor unit 1011.

As illustrated in FIG. 1 the sensor device 1010 may comprise the counting device 1015 for counting the event numbers. Each sensor unit 1011 may have its own counting device 1015 and/or there may be one counting device 1015 for all sensor units 1011. Thus, although the counting device 1015 is illustrated in FIG. 1 outside the sensor units 1011, one counting device 1015 may be implemented in each sensor unit 1011. An overall counting of event numbers can be performed at the event selection unit 1012 or even at the control unit 1013, if the event selection unit 1012 signals also the occurrence of non-selected events to the control unit 1013. Moreover, also counting of the single sensor unit 1011 event numbers may be performed centrally at the event selection unit 1012 or the control unit 1013. In fact, the counting devices 1015 of the different sensor units 1011 may be arranged anywhere within the circuitry of the sensor device 1010.

The counting device 1015 is configured to count event numbers by counting all events during a given time interval (that may be different from the predetermined time period), and by forgetting events that have occurred before that time interval.

For example, the counting device 1015 is either constituted by a digital counter configured to increase with each event detection and to decrease after a predetermined time. Alternatively, an analog counter may be constituted by a capacitor that is configured to be charged by a first predetermined amount with each event detection and to be discharged by a second predetermined amount after a predetermined time, e.g. by a leak.

These two examples are schematically illustrated in FIG. 2. The curve A shows the development of a digital counter that increases the count by a predetermined amount each time an event D is detected or selected. After the predetermined time the count decreases stepwise until the next event is detected. The curve B shows the charging and discharging of a capacitor based on the detected or selected events D. Note that the count may either be for a single sensor unit 1011 or the entire plurality of sensor units 1011.

The line C denotes a possible value for a threshold. If the threshold is exceeded, the likelihood for selection will be decreased, either for the sensor unit 1011 to which the count belongs, for said sensor unit 1011 and the group of sensor units 1011 to which is belongs, or for all sensor units 1011. Of course, several thresholds for different levels of selection likelihood decreasing may be set or the counted number may directly affect the selection likelihood as described above. The counted number may either be directly signaled to the event selection unit 1012 or the control unit 1013 or may be stored in a register, a table or the like for readout be the event selection unit 1012 or the control unit 1013. Thus, by using e.g. the count mechanisms illustrated in FIG. 2, the above described advantages due to adaption of selection thresholds or sensor unit 1011 weighing can be achieved.

As illustrated by arrow 1012b of FIG. 1, the event selection unit 1012 may be configured to acknowledge a sensor unit 1011 whose detected event is not selected by the event selection unit 1012 that it can discard the detected event and start event detection anew. As stated above, usually the sensor units 1011 will signal to the control unit 1013 that an event has been detected and hold the event detected status, until the event has been read out. Only then is the detection of another event possible. If the sensor unit 1011 is not selected for readout, it will be blocked from event detection, if there is no message to discard the detected event. This can be done in form of an acknowledgement from the event selection unit 1012. In fact, since the event selection unit 1012 knows which events were not selected, acknowledging the corresponding sensor units 1011 by the event selection unit 1012 that event detection can be started anew is highly efficient.

Regarding the selected events, the control unit 1013 may be configured to acknowledge a sensor unit 1011 whose detected event was selected by the event selection unit 1012 and received by the control unit 1013 that it can discard the detected event and start event detection anew. Thus, with regard to selected events no change corresponding to the usual method is made. The acknowledgement of selected events may also be done by the event detection unit 1012.

Thus, by acknowledging both, selected and non-selected events, the functioning of the event sensor device 1010 is ensured.

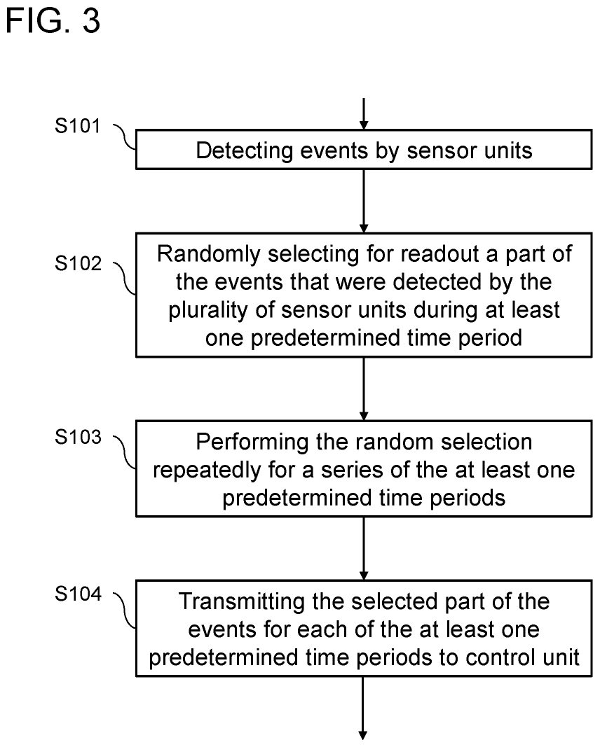

FIG. 3 shows a schematic process flow of a method for operating the sensor device 1010 as described above. The method comprises at S101 detecting events by the sensor units 1011; at S102 randomly selecting for readout a part of the events that were detected by the plurality of sensor units 1011 during at least one predetermined time period; at S103 performing the random selection repeatedly for a series of the at least one predetermined time periods; and at S104 transmitting the selected part of the events for each of the at least one predetermined time periods to the control unit 1013.

As particular useful example of a sensor device 1010 as described above can be achieved, if the sensor device 1010 is a solid state imaging device 100, and the sensor units 1011 are imaging pixels 111 arranged in a pixel array 110, each of which being capable to detect as an event a positive or negative change of intensity of light falling on the imaging pixel 111 that is larger than the respective predetermined threshold. i.e. if the sensor device is a DVS, EVS, or the like. The principle functioning of such a solid state imaging device 100 as far as event detection is concerned will be given in the following. Further, useful applications of such a solid state imaging device 100 will be described.

FIG. 4A is a block diagram of such a solid-state imaging device 100 employing event based change detection. The solid-state imaging device 100 includes a pixel array 110 with one or more imaging pixels 111, wherein each pixel 111 includes a photoelectric conversion element PD. The pixel array 110 may be a one-dimensional pixel array with the photoelectric conversion elements PD of all pixels arranged along a straight or meandering line (line sensor). In particular, the pixel array 110) may be a two-dimensional array, wherein the photoelectric conversion elements PDs of the pixels 111 may be arranged along straight or meandering rows and along straight or meandering lines.

The illustrated embodiment shows a two dimensional array of pixels 111, wherein the pixels 111 are arranged along straight rows and along straight columns running orthogonal the rows. Each pixel 111 converts incoming light into an imaging signal representing the incoming light intensity and an event signal indicating a change of the light intensity, e.g. an increase by at least an upper threshold amount and/or a decrease by at least a lower threshold amount. If necessary, the function of each pixel 111 regarding intensity and event detection may be divided and different pixels observing the same solid angle can implement the respective functions. These different pixels may be subpixels and can be implemented such that they share part of the circuitry. The different pixels may also be part of different image sensors. For the present disclosure, whenever it is referred to a pixel capable of generating an imaging signal and an event signal, this should be understood to include also a combination of pixels separately carrying out these functions as described above.

A controller 120 performs a flow control of the processes in the pixel array 110. For example, the controller 120 may control a threshold generation circuit 130 that determines and supplies thresholds to individual pixels 111 in the pixel array 110. A readout circuit 140) provides control signals for addressing individual pixels 111 and outputs information about the position of such pixels 111 that indicate an event. Since the solid-state imaging device 100 employs event-based change detection, the readout circuit 140) may output a variable amount of data per time unit.

FIG. 4B shows exemplarily details of the imaging pixels 111 in FIG. 4A as far as their event detection capabilities are concerned. Of course, any other implementation that allows detection of events can be employed. Each pixel 111 includes a photoreceptor module PR and is assigned to a pixel back-end 300, wherein each complete pixel back-end 300 may be assigned to one single photoreceptor module PR. Alternatively, a pixel back-end 300 or parts thereof may be assigned to two or more photoreceptor modules PR, wherein the shared portion of the pixel back-end 300 may be sequentially connected to the assigned photoreceptor modules PR in a multiplexed manner.

The photoreceptor module PR includes a photoelectric conversion element PD, e.g. a photodiode or another type of photosensor. The photoelectric conversion element PD converts impinging light 9 into a photocurrent Iphoto through the photoelectric conversion element PD, wherein the amount of the photocurrent Iphoto is a function of the light intensity of the impinging light 9.

A photoreceptor circuit PRC converts the photocurrent Iphoto into a photoreceptor signal Vpr. The voltage of the photoreceptor signal Vpr is a function of the photocurrent Iphoto.

A memory capacitor 310 stores electric charge and holds a memory voltage which amount depends on a past photoreceptor signal Vpr. In particular, the memory capacitor 310 receives the photoreceptor signal Vpr such that a first electrode of the memory capacitor 310 carries a charge that is responsive to the photoreceptor signal Vpr and thus the light received by the photoelectric conversion element PD. A second electrode of the memory capacitor C1 is connected to the comparator node (inverting input) of a comparator circuit 340. Thus the voltage of the comparator node. Vdiff varies with changes in the photoreceptor signal Vpr.

The comparator circuit 340 compares the difference between the current photoreceptor signal Vpr and the past photoreceptor signal to a threshold. The comparator circuit 340 can be in each pixel back-end 300, or shared between a subset (for example a column) of pixels. According to an example each pixel 111 includes a pixel back-end 300 including a comparator circuit 340, such that the comparator circuit 340 is integral to the imaging pixel 111 and each imaging pixel 111 has a dedicated comparator circuit 340.

A memory element 350 stores the comparator output in response to a sample signal from the controller 120. The memory element 350 may include a sampling circuit (for example a switch and a parasitic or explicit capacitor) and/or a digital memory circuit such as a latch or a flip-flop). In one embodiment, the memory element 350 may be a sampling circuit. The memory element 350 may be configured to store one, two or more binary bits.

An output signal of a reset circuit 380 may set the inverting input of the comparator circuit 340 to a predefined potential. The output signal of the reset circuit 380 may be controlled in response to the content of the memory element 350 and/or in response to a global reset signal received from the controller 120.

The solid-state imaging device 100 is operated as follows: A change in light intensity of incident radiation 9 translates into a change of the photoreceptor signal Vpr. At times designated by the controller 120, the comparator circuit 340 compares Vdiff at the inverting input (comparator node) to a threshold Vb applied on its non-inverting input. At the same time, the controller 120 operates the memory element 350 to store the comparator output signal Vcomp. The memory element 350 may be located in either the pixel circuit 111 or in the readout circuit 140 shown in FIG. 4A.

If the state of the stored comparator output signal indicates a change in light intensity AND the global reset signal GlobalReset (controlled by the controller 120) is active, the conditional reset circuit 380 outputs a reset output signal that resets Vdiff to a known level.

The memory element 350 may include information indicating a change of the light intensity detected by the pixel 111 by more than a threshold value.

The solid state imaging device 120 may output the addresses (where the address of a pixel 111 corresponds to its row and column number) of those pixels 111 where a light intensity change has been detected. A detected light intensity change at a given pixel is called an event. More specifically, the term ‘event’ means that the photoreceptor signal representing and being a function of light intensity of a pixel has changed by an amount greater than or equal to a threshold applied by the controller through the threshold generation circuit 130. To transmit an event, the address of the corresponding pixel 111 is transmitted along with data indicating whether the light intensity change was positive or negative. The data indicating whether the light intensity change was positive or negative may include one single bit.

To detect light intensity changes between current and previous instances in time, each pixel 111 stores a representation of the light intensity at the previous instance in time.

More concretely, each pixel 111 stores a voltage Vdiff representing the difference between the photoreceptor signal at the time of the last event registered at the concerned pixel 111 and the current photoreceptor signal at this pixel 111.

To detect events. Vdiff at the comparator node may be first compared to a first threshold to detect an increase in light intensity (ON-event), and the comparator output is sampled on a (explicit or parasitic) capacitor or stored in a flip-flop. Then Vdiff at the comparator node is compared to a second threshold to detect a decrease in light intensity (OFF-event) and the comparator output is sampled on a (explicit or parasitic) capacitor or stored in a flip-flop.

The global reset signal is sent to all pixels 111, and in each pixel 111 this global reset signal is logically ANDed with the sampled comparator outputs to reset only those pixels where an event has been detected. Then the sampled comparator output voltages are read out, and the corresponding pixel addresses sent to a data receiving device.

FIG. 4C illustrates a configuration example of the solid-state imaging device 100 including an image sensor assembly 10 that is used for readout of intensity imaging signals in form of an active pixel sensor. APS. Here, FIG. 4C is purely exemplary. Readout of imaging signals can also be implemented in any other known manner. As stated above, the image sensor assembly 10 may use the same pixels 111 or may supplement these pixels 111 with additional pixels observing the respective same solid angles. In the following description the exemplary case of usage of the same pixel array 110 is chosen.

The image sensor assembly 10 includes the pixel array 110, an address decoder 12, a pixel timing driving unit 13, an ADC (analog-to-digital converter) 14, and a sensor controller 15.

The pixel array 110 includes a plurality of pixel circuits 11P arranged matrix-like in rows and columns. Each pixel circuit 11P includes a photosensitive element and FETs (field effect transistors) for controlling the signal output by the photosensitive element.

The address decoder 12 and the pixel timing driving unit 13 control driving of each pixel circuit 11P disposed in the pixel array 110. That is, the address decoder 12 supplies a control signal for designating the pixel circuit 11P to be driven or the like to the pixel timing driving unit 13 according to an address, a latch signal, and the like supplied from the sensor controller 15. The pixel timing driving unit 13 drives the FETs of the pixel circuit 11P according to driving timing signals supplied from the sensor controller 15 and the control signal supplied from the address decoder 12. The electric signals of the pixel circuits 11P (pixel output signals, imaging signals) are supplied through vertical signal lines VSL to ADCs 14, wherein each ADC 14 is connected to one of the vertical signal lines VSL, and wherein each vertical signal line VSL is connected to all pixel circuits 11P of one column of the pixel array unit 11. Each ADC 14 performs an analog-to-digital conversion on the pixel output signals successively output from the column of the pixel array unit 11 and outputs the digital pixel data DPXS to the signal processing unit 19. To this purpose, each ADC 14 includes a comparator 23, a digital-to-analog converter (DAC) 22 and a counter 24.

The sensor controller 15 controls the image sensor assembly 10. That is, for example, the sensor controller 15 supplies the address and the latch signal to the address decoder 12, and supplies the driving timing signal to the pixel timing driving unit 13. In addition, the sensor controller 15 may supply a control signal for controlling the ADC 14.

The pixel circuit 11P includes the photoelectric conversion element PD as the photosensitive element. The photoelectric conversion element PD may include or may be composed of, for example, a photodiode. With respect to one photoelectric conversion element PD, the pixel circuit 11P may have four FETs serving as active elements, i.e., a transfer transistor TG, a reset transistor RST, an amplification transistor AMP, and a selection transistor SEL.

The photoelectric conversion element PD photoelectrically converts incident light into electric charges (here, electrons). The amount of electric charge generated in the photoelectric conversion element PD corresponds to the amount of the incident light.

The transfer transistor TG is connected between the photoelectric conversion element PD and a floating diffusion region FD. The transfer transistor TG serves as a transfer element for transferring charge from the photoelectric conversion element PD to the floating diffusion region FD. The floating diffusion region FD serves as temporary local charge storage. A transfer signal serving as a control signal is supplied to the gate (transfer gate) of the transfer transistor TG through a transfer control line.

Thus, the transfer transistor TG may transfer electrons photoelectrically converted by the photoelectric conversion element PD to the floating diffusion FD.

The reset transistor RST is connected between the floating diffusion FD and a power supply line to which a positive supply voltage VDD is supplied. A reset signal serving as a control signal is supplied to the gate of the reset transistor RST through a reset control line.

Thus, the reset transistor RST serving as a reset element resets a potential of the floating diffusion FD to that of the power supply line.

The floating diffusion FD is connected to the gate of the amplification transistor AMP serving as an amplification element. That is, the floating diffusion FD functions as the input node of the amplification transistor AMP serving as an amplification element.

The amplification transistor AMP and the selection transistor SEL are connected in series between the power supply line VDD and a vertical signal line VSL.

Thus, the amplification transistor AMP is connected to the signal line VSL through the selection transistor SEL and constitutes a source-follower circuit with a constant current source 21 illustrated as part of the ADC 14.

Then, a selection signal serving as a control signal corresponding to an address signal is supplied to the gate of the selection transistor SEL through a selection control line, and the selection transistor SEL is turned on.

When the selection transistor SEL is turned on, the amplification transistor AMP amplifies the potential of the floating diffusion FD and outputs a voltage corresponding to the potential of the floating diffusion FD to the signal line VSL. The signal line VSL transfers the pixel output signal from the pixel circuit 11P to the ADC 14.

Since the respective gates of the transfer transistor TG, the reset transistor RST, and the selection transistor SEL are, for example, connected in units of rows, these operations are simultaneously performed for each of the pixel circuits 11P of one row. Further, it is also possible to selectively read out single pixels or pixel groups.

The ADC 14 may include a DAC 22, the constant current source 21 connected to the vertical signal line VSL, a comparator 23, and a counter 24.

The vertical signal line VSL, the constant current source 21 and the amplifier transistor AMP of the pixel circuit 11P combine to a source follower circuit.

The DAC 22 generates and outputs a reference signal. By performing digital-to-analog conversion of a digital signal increased in regular intervals, e.g. by one, the DAC 22 may generate a reference signal including a reference voltage ramp. Within the voltage ramp, the reference signal steadily increases per time unit. The increase may be linear or not linear.

The comparator 23 has two input terminals. The reference signal output from the DAC 22 is supplied to a first input terminal of the comparator 23 through a first capacitor C1. The pixel output signal transmitted through the vertical signal line VSL is supplied to the second input terminal of the comparator 23 through a second capacitor C2.

The comparator 23 compares the pixel output signal and the reference signal that are supplied to the two input terminals with each other, and outputs a comparator output signal representing the comparison result. That is, the comparator 23 outputs the comparator output signal representing the magnitude relationship between the pixel output signal and the reference signal. For example, the comparator output signal may have high level when the pixel output signal is higher than the reference signal and may have low level otherwise, or vice versa. The comparator output signal VCO is supplied to the counter 24.

The counter 24 counts a count value in synchronization with a predetermined clock. That is, the counter 24 starts the count of the count value from the start of a P phase or a D phase when the DAC 22 starts to decrease the reference signal, and counts the count value until the magnitude relationship between the pixel output signal and the reference signal changes and the comparator output signal is inverted. When the comparator output signal is inverted, the counter 24 stops the count of the count value and outputs the count value at that time as the AD conversion result (digital pixel data DPXS) of the pixel output signal.

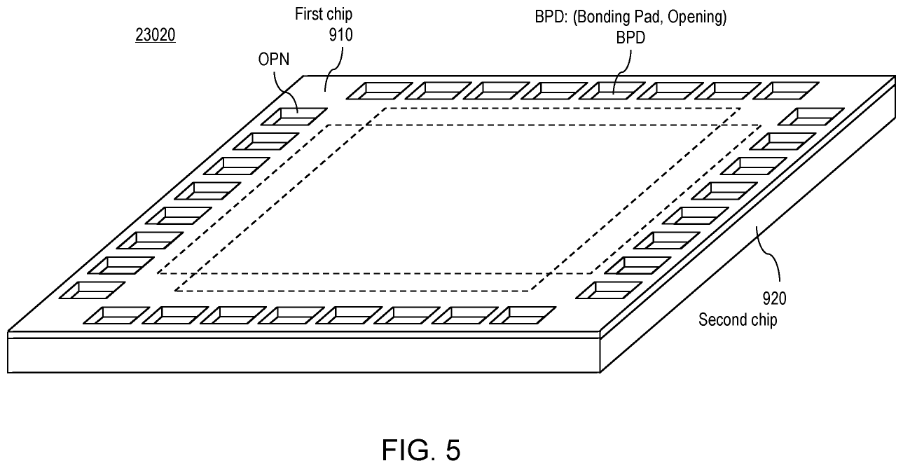

FIG. 5 is a perspective view showing an example of a laminated structure of a solid-state imaging device 23020 with a plurality of pixels arranged matrix-like in array form in which the functions described above may be implemented. Each pixel includes at least one photoelectric conversion element.

The solid-state imaging device 23020 has the laminated structure of a first chip (upper chip) 910 and a second chip (lower chip) 920.

The laminated first and second chips 910, 920 may be electrically connected to each other through TC(S)Vs (Through Contact (Silicon) Vias) formed in the first chip 910.

The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel, e.g., the photoelectric conversion elements arranged in array form. For example, the first chip 910 may include only the photoelectric conversion elements.

Alternatively, the first chip 910 may include further elements of each photoreceptor module. For example, the first chip 910 may include, in addition to the photoelectric conversion elements, at least some or all of the n-channel MOSFETs of the photoreceptor modules. Alternatively, the first chip 910 may include each element of the photoreceptor modules.

The first chip 910 may also include parts of the pixel back-ends 300. For example, the first chip 910 may include the memory capacitors, or, in addition to the memory capacitors sample/hold circuits and/or buffer circuits electrically connected between the memory capacitors and the event-detecting comparator circuits. Alternatively, the first chip 910 may include the complete pixel back-ends. With reference to FIG. 4A, the first chip 910 may also include at least portions of the readout circuit 140, the threshold generation circuit 130 and/or the controller 120 or the entire control unit.

The second chip 920 may be mainly a logic chip (digital chip) that includes the elements complementing the circuits on the first chip 910 to the solid-state imaging device 23020. The second chip 920 may also include analog circuits, for example circuits that quantize analog signals transferred from the first chip 910 through the TCVs.

The second chip 920 may have one or more bonding pads BPD and the first chip 910 may have openings OPN for use in wire-bonding to the second chip 920.

The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

Typically, the first chip 910 includes a p-type substrate and formation of p-channel MOSFETs typically implies the formation of n-doped wells separating the p-type source and drain regions of the p-channel MOSFETs from each other and from further p-type regions. Avoiding the formation of p-channel MOSFETs may therefore simplify the manufacturing process of the first chip 910.

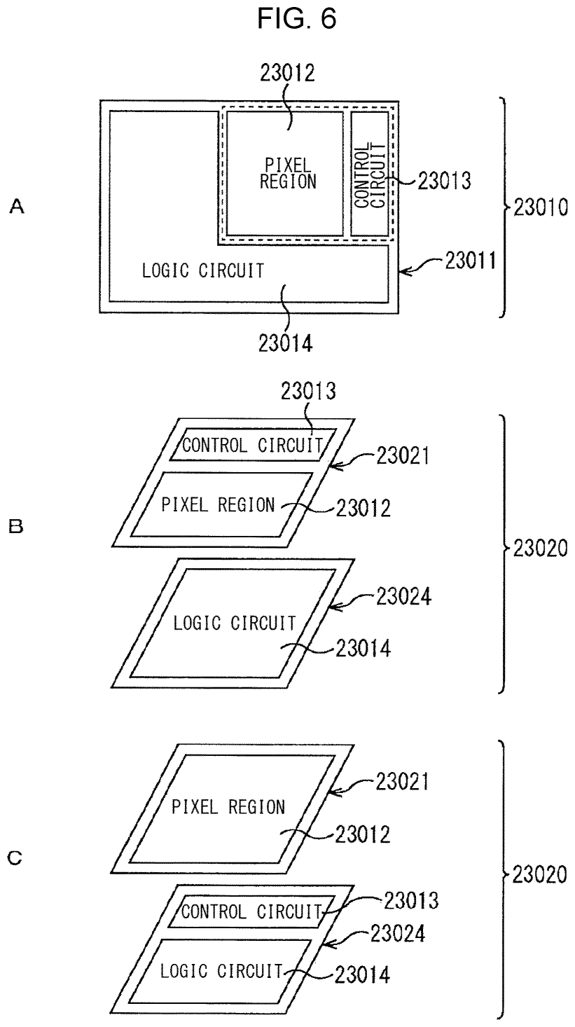

FIG. 6 illustrates schematic configuration examples of solid-state imaging devices 23010, 23020.

The single-layer solid-state imaging device 23010 illustrated in part A of FIG. 6 includes a single die (semiconductor substrate) 23011. Mounted and/or formed on the single die 23011 are a pixel region 23012 (photoelectric conversion elements), a control circuit 23013 (readout circuit, threshold generation circuit, controller, control unit), and a logic circuit 23014 (pixel back-end). In the pixel region 23012, pixels are disposed in an array form. The control circuit 23013 performs various kinds of control including control of driving the pixels. The logic circuit 23014 performs signal processing.

Parts B and C of FIG. 6 illustrate schematic configuration examples of multi-layer solid-state imaging devices 23020 with laminated structure. As illustrated in parts B and C of FIG. 6, two dies (chips), namely a sensor die 23021 (first chip) and a logic die 23024 (second chip), are stacked in a solid-state imaging device 23020. These dies are electrically connected to form a single semiconductor chip.

With reference to part B of FIG. 6, the pixel region 23012 and the control circuit 23013 are formed or mounted on the sensor die 23021, and the logic circuit 23014 is formed or mounted on the logic die 23024. The logic circuit 23014 may include at least parts of the pixel back-ends. The pixel region 23012 includes at least the photoelectric conversion elements.

With reference to part C of FIG. 6, the pixel region 23012 is formed or mounted on the sensor die 23021, whereas the control circuit 23013 and the logic circuit 23014 are formed or mounted on the logic die 23024.

According to another example (not illustrated), the pixel region 23012 and the logic circuit 23014, or the pixel region 23012 and parts of the logic circuit 23014 may be formed or mounted on the sensor die 23021, and the control circuit 23013 is formed or mounted on the logic die 23024.

Within a solid-state imaging device with a plurality of photoreceptor modules PR, all photoreceptor modules PR may operate in the same mode. Alternatively, a first subset of the photoreceptor modules PR may operate in a mode with low SNR and high temporal resolution and a second, complementary subset of the photoreceptor module may operate in a mode with high SNR and low temporal resolution. The control signal may also not be a function of illumination conditions but, e.g., of user settings.

### <Application Example to Mobile Body>

The technology according to the present disclosure may be realized, e.g., as a device mounted in a mobile body of any type such as automobile, electric vehicle, hybrid electric vehicle, motorcycle, bicycle, personal mobility, airplane, drone, ship, or robot.

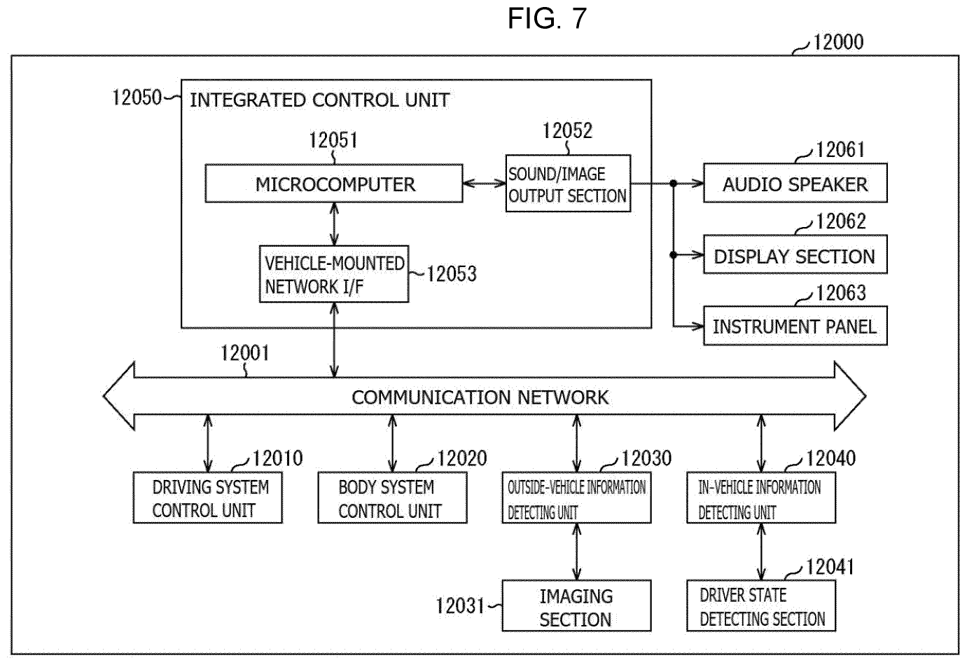

FIG. 7 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 7, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging sensor with event detection and photoreceptor modules according to the present disclosure. The imaging section 12031 may output the electric signal as position information identifying pixels having detected an event. The light received by the imaging section 12031 may be visible light, or may be invisible light such as infrared rays or the like.

The in-vehicle information detecting unit 12040 detects information about the inside of the vehicle and may be or may include a solid-state imaging sensor with event detection and photoreceptor modules according to the present disclosure. The in-vehicle information detecting unit 12040 is, for example, connected with a driver state detecting section 12041 that detects the state of a driver. The driver state detecting section 12041, for example, includes a camera focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040), and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030) or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 7, an audio speaker 12061, a display section 12062, and an instrument panel 12063 are illustrated as the output device. The display section 12062 may, for example, include at least one of an on-board display or a head-up display.

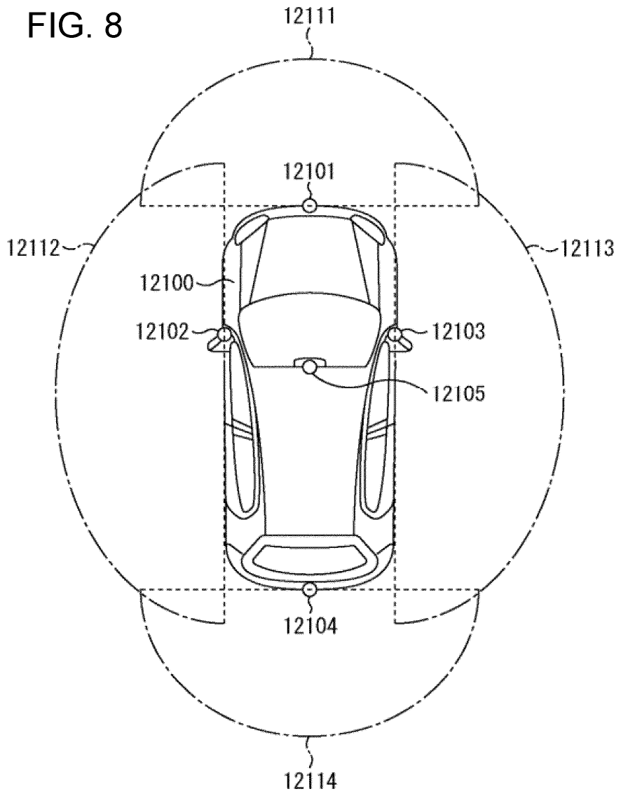

FIG. 8 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 8 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure is applicable has been described above. By applying the photoreceptor modules for obtaining event-triggered image information, the image data transmitted through the communication network may be reduced and it may be possible to reduce power consumption without adversely affecting driving support.

Additionally, embodiments of the present technology are not limited to the above-described embodiments, but various changes can be made within the scope of the present technology without departing from the gist of the present technology.

The solid-state imaging device according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

Note that the present technology can also be configured as described below:
(1) A sensor device comprising
   a plurality of sensor units each of which being capable to detect the intensity of an influence on the sensor unit, and to detect as an event a positive or negative change of the intensity of the influence that is larger than a respective predetermined threshold;
   an event selection unit configured to randomly select for readout a part of the events that were detected by the plurality of sensor units during at least one predetermined time period and to perform the random selection repeatedly for a series of the at least one predetermined time periods; and
   a control unit configured to receive the selected part of the events for each of the at least one predetermined time periods.
(2) The sensor device according to (1), wherein
   the event selection unit comprises a random number generator that is configured to generate a random series of numbers according to a probability distribution, with one number associated to each event that was detected during the at least one predetermined time period; and
   the event selection unit is configured to select those events that are associated to a number above a threshold.
(3) The sensor device according to (1) or (2), wherein
   the event selection unit is configured to adjust the likelihood for selection of an event generated by one of the sensor units based on the number of events previously detected by said sensor unit during a predetermined time duration, and
   the likelihood for selection decreases with an increasing number of previously detected events.
(4) The sensor device according to any one of (1) to (3), wherein
   the event selection unit is configured to adjust the likelihood for selection of an event generated by one of the sensor units based on the number of events previously detected by said sensor unit and sensor units within a predetermined distance around said sensor unit during a predetermined time duration, and
   the likelihood for selection decreases with an increasing number of previously detected events.
(5) The sensor device according to any one of (1) to (4), wherein
   the event selection unit is configured to adjust the likelihood for selection of an event depending on the total number of events detected during the at least one predetermined time period; and
   the likelihood for selection decreases with an increase of the total number.
(6) The sensor device according to (5), wherein
   the event selection unit is configured to adjust the likelihood for selection such that a total number of selected events lies within a predetermined range.
(7) The sensor device according to any one of (1) to (6), wherein
   due to the random selection the number of the selected events is between 5% and 35%, preferably between 10% and 15%, of the total number of events detected during the at least one predetermined time period.
(8) The sensor device according to any one of (1) to (7), further comprising
   a counting device for counting event numbers: wherein
   the counting device is either constituted by
      a digital counter configured to increase with each event detection and to decrease after a predetermined time: or
      a capacitor that is configured to be charged by a first predetermined amount with each event detection and to be discharged by a second predetermined amount after a predetermined time; wherein
   there is one counting device for each sensor unit and/or one counting device for all sensor units.
(9) The sensor device according to any one of (1) to (8), wherein
   the influence detectable by the sensor units is either electromagnetic radiation, sound waves, mechanical stress or concentration of chemical components.
(10) The sensor device according to any one of (1) to (9), wherein
   the event selection unit is configured to acknowledge a sensor unit whose detected event is not selected by the event selection unit that it can discard the detected event and start event detection anew.
(11) The sensor device according to any one of (1) to (10), wherein
   the control unit is configured to acknowledge a sensor unit whose detected event was selected by the event selection unit and received by the control unit that is can discard the detected event and start event detection anew.
(12) The sensor device according to any one of (1) to (11), wherein
   the sensor device is a solid state imaging device;
   the sensor units are imaging pixels arranged in a pixel array, each of which being capable to generate an imaging signal depending on the intensity of light falling on the imaging pixel, and to detect as an event a positive or negative change of light intensity that is larger than the respective predetermined threshold.
(13) A method for operating a sensor device as in (1) to (12) that comprises a plurality of sensor units each of which being capable to detect the intensity of an influence on the sensor unit, and to detect as an event a positive or negative change of the intensity of the influence that is larger than a respective predetermined threshold, the method comprising:
   detecting events by the sensor units;
   randomly selecting for readout a part of the events that were detected by the plurality of sensor units during at least one predetermined time period and performing the random selection repeatedly for a series of the at least one predetermined time periods; and
   transmitting the selected part of the events for each of the at least one predetermined time periods to a control unit of the sensor device.

1. A sensor device comprising
a plurality of sensor units each of which being capable to detect the intensity of an influence on the sensor unit, and to detect as an event a positive or negative change of the intensity of the influence that is larger than a respective predetermined threshold;
an event selection unit configured to randomly select for readout a part of the events that were detected by the plurality of sensor units during at least one predetermined time period and to perform the random selection repeatedly for a series of the at least one predetermined time periods; and
a control unit configured to receive the selected part of the events for each of the at least one predetermined time periods.

2. The sensor device according to claim 1, wherein
the event selection unit comprises a random number generator that is configured to generate a random series of numbers according to a probability distribution, with one number associated to each event that was detected during the at least one predetermined time period; and
the event selection unit is configured to select those events that are associated to a number above a threshold.

3. The sensor device according to claim 1, wherein
the event selection unit is configured to adjust the likelihood for selection of an event generated by one of the sensor units based on the number of events previously detected by said sensor unit during a predetermined time duration, and
the likelihood for selection decreases with an increasing number of previously detected events.

4. The sensor device according to claim 1, wherein
the event selection unit is configured to adjust the likelihood for selection of an event generated by one of the sensor units based on the number of events previously detected by said sensor unit and sensor units within a predetermined distance around said sensor unit during a predetermined time duration, and
the likelihood for selection decreases with an increasing number of previously detected events.

5. The sensor device according to claim 1, wherein
the event selection unit is configured to adjust the likelihood for selection of an event depending on the total number of events detected during the at least one predetermined time period; and
the likelihood for selection decreases with an increase of the total number.

6. The sensor device according to claim 5, wherein
the event selection unit is configured to adjust the likelihood for selection such that a total number of selected events lies within a predetermined range.

7. The sensor device according to claim 1, wherein
due to the random selection the number of the selected events is between 5% and 35%, preferably between 10% and 15%, of the total number of events detected during the at least one predetermined time period.

8. The sensor device according to claim 1, further comprising
a counting device for counting event numbers: wherein
the counting device is either constituted by
a digital counter configured to increase with each event detection and to decrease after a predetermined time: or
a capacitor that is configured to be charged by a first predetermined amount with each event detection and to be discharged by a second predetermined amount after a predetermined time; wherein
there is one counting device for each sensor unit and/or one counting device for all sensor units.

9. The sensor device according to claim 1, wherein
the influence detectable by the sensor units is either electromagnetic radiation, sound waves, mechanical stress or concentration of chemical components.

10. The sensor device according to claim 1, wherein
the event selection unit is configured to acknowledge a sensor unit whose detected event is not selected by the event selection unit that it can discard the detected event and start event detection anew.

11. The sensor device according to claim 1, wherein
the control unit is configured to acknowledge a sensor unit whose detected event was selected by the event selection unit and received by the control unit that it can discard the detected event and start event detection anew.

12. The sensor device according to claim 1, wherein
the sensor device is a solid state imaging device;
the sensor units are imaging pixels arranged in a pixel array, each of which being capable to detect as an event a positive or negative change of intensity of light falling on the imaging pixel that is larger than the respective predetermined threshold.

13. A method for operating a sensor device comprising a plurality of sensor units each of which being capable to detect the intensity of an influence on the sensor unit, and to detect as an event a positive or negative change of the intensity of the influence that is larger than a respective predetermined threshold, the method comprising:
detecting events by the sensor units;
randomly selecting for readout a part of the events that were detected by the plurality of sensor units during at least one predetermined time period;
performing the random selection repeatedly for a series of the at least one predetermined time periods; and
transmitting the selected part of the events for each of the at least one predetermined time periods to a control unit of the sensor device.
